(19) United States
(12) Patent Application Publication
(10) Pub. No.: US 2011/0001770 A1
(43) Pub. Date: Jan. 6, 2011

(54) MAIL PROCESSING SYSTEM WITH PRINTER MAINTENANCE OPERATIONS TO PREVENT POTENTIAL CLOGGING OF PRINT HEAD WHEN DIFFERENT INKS ARE UTILIZED

(75) Inventor: Christopher M. Giles, Monroe, CT (US)

Correspondence Address: PITNEY BOWES INC.;INTELLECTUAL PROPERTY & TECH. LAW DEPT., 35 WATERVIEW DRIVE, MSC 26-22, SHELTON, CT, 06484, US

(73) Assignee: Pitney Bowes Inc., Stamford, CT (US)

(21) Appl. No.: 12/477,970

(22) Filed: Jun. 4, 2009

(51) Int. Cl. B41J 29/38

(52) U.S. Cl. 347/6

(57) ABSTRACT

A mail processing system and method that will that reduce clogging of the print head nozzles due to the use of different inks is provided. When an ink tank is being replaced in a mailing system, the system controller determines if the ink in the new ink tank is a known ink type that is deemed to be compatible with the ink from the ink tank being replaced. If the new ink is deemed to be not compatible with the ink from the tank being replaced, a maintenance operation is performed to remove the ink from the ink tank being replaced that may remain in the supply path and print head from the system. By removing the ink remaining from the ink tank being replaced out of the system, there is minimal ink left in the supply path or print head to mix with the new ink.

### FIELD OF THE INVENTION

The invention disclosed herein relates generally to mail processing systems, and more particularly to a mail processing system that performs printer maintenance operations to prevent clogging of the print head when different inks are used.

### BACKGROUND OF THE INVENTION

Mail processing systems for preparing mail pieces, e.g., stuffing envelopes, and/or printing postage indicia on envelopes and other forms of mail pieces have long been well known and have enjoyed considerable commercial success. There are many different types of mail processing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters.

Modern mail processing systems utilize digital printing techniques for producing images on a mail piece. Conventional digital printing techniques include bubble jet and ink jet, each of which produces an image in a dot matrix pattern. With digital printing, individual print head elements (such as resistors or piezoelectric elements) are selectively electronically stimulated to expel from nozzles drops of ink from an ink supply onto a substrate, e.g., a mail piece. In either case, by controlling the timing of energizing of the individual print head elements in conjunction with the relative movement between the print head and the mail piece, a dot matrix pattern is produced in the visual form of the desired image. In the case of mail processing systems, the image may be, for example, a postage indicium that evidences payment of postage.

The use of a digital printing technology in mail processing systems, however, presents other issues that must be taken into consideration. For example, replacement of the ink supply is required to ensure that continued satisfactory printing occurs. When the ink supply is replaced, it is possible that a different ink may be used in the replacement supply which may not be compatible with the ink that remains in the printing system from the depleted ink supply, e.g., ink remaining in the print head and in the supply path from the ink tank to the print head. When the ink from the replacement supply mixes with the ink left in the printing system, the inks may react with one another in such a manner that the combined ink may cause clogging of the nozzles of the print head or supply path, thereby deteriorating the efficiency of the print head or even rendering the print head inoperable.

Thus, there exists a need for a mail processing system that will prevent clogging of the print head nozzles due to the use of different inks.

### SUMMARY OF THE INVENTION

The present invention alleviates the problems associated with the prior art and provides a mail processing system that will that reduce clogging of the print head nozzles due to the use of different inks.

In accordance with embodiments of the present invention, when an ink tank is being replaced in a mailing system, the system controller determines if the ink in the new ink tank is deemed to be compatible with the ink from the ink tank being replaced. This can be done based on identifying information read from a memory chip on the ink tank. If the ink in the new ink tank is deemed to be not compatible with the ink from the tank being replaced, a maintenance operation is performed to remove the ink remaining from the ink tank being replaced in the supply path and print head from the system. By removing the remaining ink from the ink tank being replaced out of the system, there is minimal ink left in the supply path or print head to mix with the new ink, thereby preventing any problems associated with such mixing, e.g., clogging of the print head nozzles or supply path.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a mail processing system according to an embodiment of the present invention;

FIG. 2 illustrates in flow diagram form the operation of the mail processing system of FIG. 1 according to an embodiment of the present invention; and

FIG. 3 illustrates in flow diagram form an example of determining compatibility of inks.

### DETAILED DESCRIPTION OF THE PRESENT INVENTION

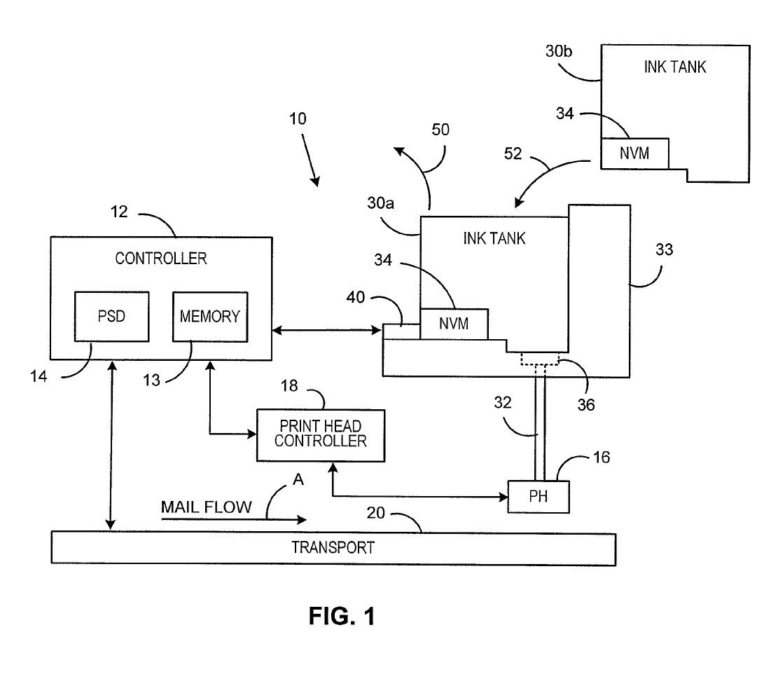

In describing the present invention, reference is made to the drawings, wherein there is seen in FIG. 1 a portion of a mail processing system 10 according to an embodiment of the present invention. It should be noted that while the following description is being made with respect to a mail processing system, the present invention is not so limited and can be utilized in any type of document printing system. System 10 includes a control unit, referred to herein as controller 12, that preferably includes one or more controller units, such as, for example, a microprocessor, general or special purpose processor or the like, to control operation of the mail processing system 10. Specifically, the controller 12, in conjunction with one or more other processors or controllers (not shown), provides all user interfaces, executes control of the mail processing system 10, calculates postage for debit based upon rate tables, provides the conduit for an associated Postal Security Device (PSD) 14 to transfer postage indicia for printing, operates with peripherals for accounting, printing and weighing, and conducts communications with a data center for postage funds refill, software download, rates download, and market-oriented data capture. The PSD 14, which is preferably embedded in the controller 12, contains one or more registers that store the accounting information concerning usage, such as, for example, an ascending register, descending register, piece count register, and the like. The controller 12, in conjunction with the embedded PSD 14, provides the system meter that satisfies U.S. and international postal regulations regarding closed system information-based indicia postage (IBIP) meters. A memory device 13 provides storage for information utilized by the controller 12.

Mail processing system 10 further includes a printing device, referred to as print head 16, that is controlled by a print head controller 18. The print head controller 18 is coupled to the controller 12. The print head controller 18 controls operations of print head 16 related to management of data from the controller 12. Management of the data can include, for example, the decryption (if encrypted when received from the controller 12), grouping, formatting and distribution of data between groups of ink jets in the print head 16, generation of the timing signals necessary for firing the ink jets of the print head 16, collection of usage information of the print head 16, and detection of overheating conditions in the print head 16. Controller 18 (or other suitable controller) can also control operations of print head 16 related to maintenance functions that could include, for example, performing print head cleaning functions, e.g., purging or spitting to clear nozzles of the print head 16, controlling positioning of the print head 16 to ensure it is in a capped position when not printing, ensuring the print head 16 is capped properly when in the capped position, monitoring the voltages being applied to fire the ink jets of the print head 16, and monitoring for error conditions during operation including improper positioning of the print head 16, overheating of the print head 16, etc. It should be noted that the print head controller 18 and the print head 16 may be integrated into a single unit, or alternatively the print head controller 18 may be integral to the controller 12.

Mail processing system 10 further preferably includes a transport 20 that can include, for example, rollers and/or belts, that are utilized to transport mail pieces along a transport path through the mail processing system 10 in the direction indicated by arrow A. The print head 16 is located along the transport path. The transport 20 will transport the mail pieces past the print head 16 such that printing by the print head 16 can occur on each mail piece. Sensors (not shown) located along the transport 20 provide signals to the controller 12 to indicate the position of a mail piece on the transport 20.

Mail processing system 10 includes a removable ink tank 30a that couples to a supply path 32, such as, for example, a supply tube, via a coupler 36 when the ink tank 30a is properly inserted into a holding device 33. The coupler 36 may include, for example, a needle that pierces a septum of the ink tank 30a to allow ink to flow from the ink tank 30a to the supply path 32. The print head 16 receives ink from the ink tank 30a via supply path 32. The length of the supply path 32 is dependent upon the distance of the ink tank 30a from the print head 16. In some cases, the ink tank 30a may be remote from the print head 16 and the supply path 32 may consist of several inches of tubing. In other cases, the ink tank 30a may sit directly on top of the print head 16, in which case the supply path 32 may consist of the coupler 36. The ink tank 30 also preferably includes a memory device, such as a non-volatile memory (NVM) device 34, that stores information about the ink tank 30a, which can include, for example, a serial or identification number, manufacturer name, type and/or color of ink, size of the ink tank, a flag indicating if the ink tank has previously been emptied, etc. When the ink tank 30a is properly inserted into the holding device 33, the NVM 34 mates with a connector 40 that is coupled to a controller, such as, for example, controller 12, thereby allowing data to be written into and read from the NVM 34.

As the mail processing system 10 operates to process envelopes by printing information, e.g., address information, postage indicia, etc., thereon, the ink from the ink tank 30a is utilized. When the ink supply from the ink tank 30a reaches some threshold level, the system 10 will provide a signal to the user that the ink tank 30a must be replaced with a new ink tank having a fresh supply of ink. Such a threshold level may be determined, for example, using one or more sensors (not shown) within the ink tank 30a, or by the print head controller 18 maintaining a record of use, e.g., drop counts, and determining based on the usage when the ink from ink tank 30a has been depleted. It is also preferable that when the threshold is reached the system 10 will not attempt to perform any printing using the print head 16 to prevent potential damage to the print head 16 that can be caused by performing a print operation without any ink being supplied to the print head 16. To protect against variations in the threshold detection, the threshold is preferably set with a safety margin such that that ink tank 30a will not run completely dry, even if the threshold detection is not completely accurate. This will result in some ink still remaining in the ink tank 32, as well as ink from the ink tank 30a remaining in the supply path 32 and print head 16, even after the ink tank 30a is removed (as designated by the arrow 50 in FIG. 1). For example, some print heads may have a small reservoir that can contain up to 9 cc of ink. The amount of ink contained in the supply path 32 is dependent upon the length of the supply path 32, but typically could contain between 1-2 cc of ink.

When a new ink tank 30b is inserted into the system, designated by arrow 52 of FIG. 1, ink from the ink tank 30b will mix with ink from ink tank 30a that remains in the supply path 32 and print head 16. If the inks from the different tanks 30a, 30b are similar or compatible, there are generally no issues with the ink from the new tank 30b mixing with the ink from the tank 30a that remains in the supply path 32 or print head 16. If, however, the inks are not the same or are not compatible, the mixing of the ink from the new tank 30b with the ink remaining from the tank 30a can have negative consequences with respect to the operation of the print head 16 and thus the overall performance of the system 10. For example, the inks may have different pH levels, with the ink from the tank 30a being acidic and the ink from the tank 30b being basic (or vice-versa). Upon mixing of these inks, a precipitate can form in the supply path 32 and/or the print head 16, which will cause the supply path 32 and/or nozzles of the print head 16 to become clogged. While forming a precipitate upon mixing is one problem with incompatible inks, it is not the only one. Upon mixing of incompatible inks, the properties of the mixed ink, such as, for example, solubility, waterfastness, color, etc. can also be compromised such that the mixed ink does not perform at acceptable levels for readability, drying, etc. Thus, if the chemical composition of the inks is different, there is the potential to negatively impact the performance of the system 10 with respect to the printing of postage indicia.

Since postal services accept indicia printed by mail processing systems as conclusive proof of payment of the amount of postage indicated, such devices are in effect machines for printing money. As a result postal services have imposed high standards for the print quality of indicia images produced by such machines, to ensure that the postal verification equipment can properly read and decode the barcodes included in the indicium. Even if a postage indicium is valid, if the verification equipment is unable to read the indicium due to poor print quality, verification will not be possible. It is therefore necessary to ensure that the printing systems utilized by the mail processing systems are capable of consistently producing high quality images to increase the read rates of such images. Any clogging of the nozzles of the print head 16 or supply path 32, as well as any degradation of the properties of the ink, could lead to poor quality images that are unable to be read by verification equipment, thereby rendering the images useless and resulting in the loss of funds expended for the payment of the postage for the unreadable indicium.

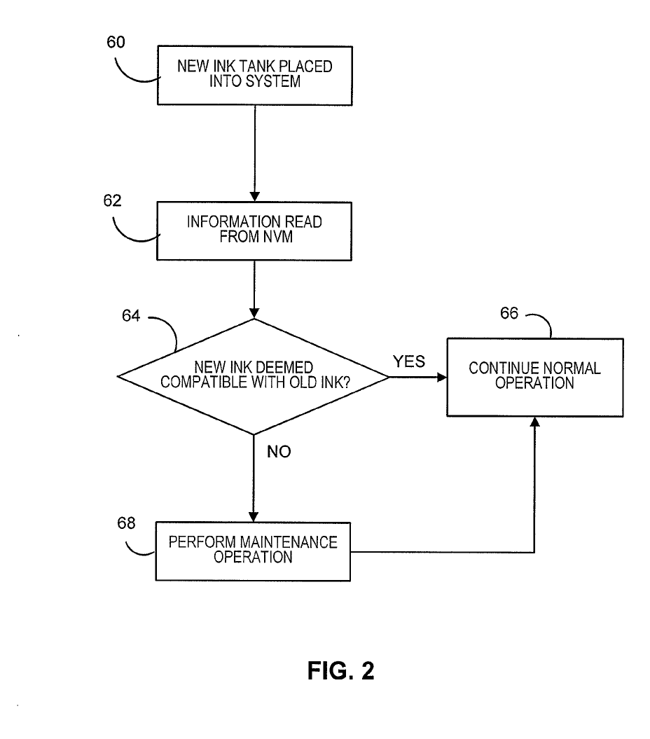

FIG. 2 illustrates in flow diagram form the operation of mail processing system 10 according to an embodiment of the invention such that the issues caused by incompatible inks mixing can be mitigated if not entirely eliminated. In step 60, a new ink tank, e.g., ink tank 30b, is placed into the system 10. In step 62, the controller 12 reads the information included in the NVM 34 of the ink tank 30b. Such information can include, for example, a serial or identification number, manufacturer name, type and/or color of ink, size of the ink tank, a flag indicating whether the ink tank has previously been emptied (refill flag), or any other information that can be used by the controller 12 to determine if the ink tank 30b is a recognized ink supply. The information obtained from the NVM 34 will be utilized as described below.

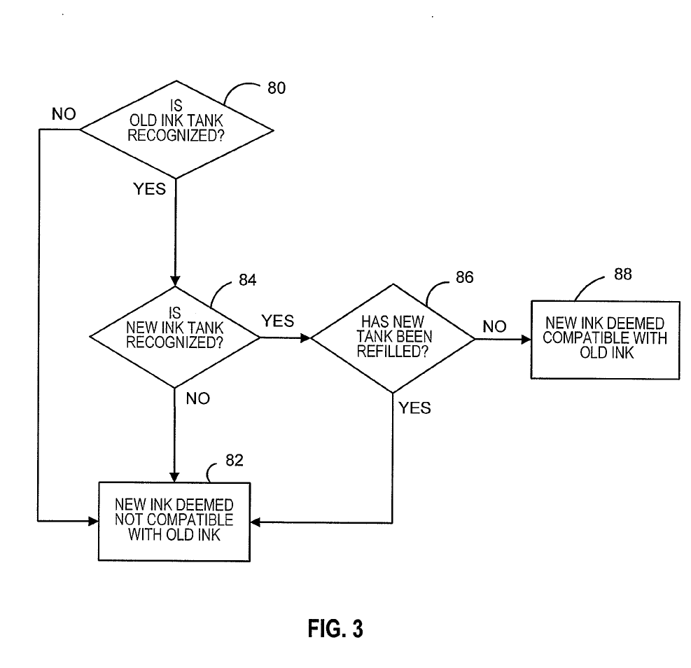

In step 64, the controller 12 can determine if, based on the information read from the NVM 34 in step 62, the ink contained in the ink tank 30b is deemed to be compatible with the ink from the ink tank 30a that is being replaced. Inks are deemed to be compatible if they have the same or very similar composition (and therefore can be mixed together without any negative consequences with respect to the operation of the print head 16 and thus the overall performance of the system 10), or have different compositions but are known not to cause any negative consequences with respect to the operation of the print head 16 and thus the overall performance of the system 10 when mixed together. An example of determining whether inks are deemed to be compatible is described below with respect to FIG. 3. If in step 64 it is determined that the ink contained within the ink tank 30b is deemed to be compatible with the ink from the ink tank 30a that is being replaced, then in step 66 the system 10 will continue with normal operation, as there is a reasonable assurance that the ink from the new tank will not react with the ink remaining from the old ink tank in a manner that will negatively impact the performance of the system 10.

If in step 64 it is determined that the ink contained within the ink tank 30b is deemed to be not compatible with the ink from the ink tank 30a, then to minimize the effects of any reaction that may occur when the two inks are mixed, in step 68 the controller 12 causes the print head controller 18 to perform a maintenance operation to remove all or substantially all of the ink remaining from the ink tank 30a that is being replaced that remains in the supply path 32 and print head 16. Such a maintenance operation preferably includes a flushing of the system with the new ink from the ink tank 30b by performing a purge or spitting operation, or any other type of operation, in which a sufficient quantity of ink is expelled from the print head to remove from the print head 16 and supply path 32 any remaining ink from the replaced ink tank 30a, and preferably to fill or almost completely fill the print head 16 and supply path 32 with ink from the new ink tank 30b. For example, a normal purge operation performed as part of the normal maintenance on an ink jet print head will typically utilize less than 1 cc of ink. A flushing of the system to clear the supply path 32 and print head 16 of remaining ink can require, for example, expelling approximately 10 cc to 11 cc of ink from the print head 16. It should be understood that the amount of ink required to be expelled is dependent upon the reservoir size of the print head 16 as well as the length of the supply path 32, and can be programmed into the print head controller 18 to ensure a sufficient quantity of ink is expelled to flush the system. Although there may be some mixing of the inks during the maintenance operation, the effects of such mixing are minimized as there is insufficient time for the inks to react and cause any of the problems associated with such reactions as noted above. This is due to the mixed inks also being removed from the system when they are mixed, thereby minimizing the effects of any such mixing. Additionally, the mixed inks are not used for printing images, thereby removing any potential problems (e.g., readability, drying, color fastness, etc.) that may be caused by using the mixed inks for printing images. The maintenance operation minimizes, if not eliminates, any ink remaining in the system 10 from the old ink tank 30a. Since there is very little to no old ink remaining, after the maintenance operation has occurred there will be minimal to no reactions between the inks that will negatively impact the performance of the system 10. After the maintenance operation has been performed in step 68, the system can return to normal operation in step 66.

Referring now to FIG. 3, there is illustrated in flow diagram form an example of determining compatibility of inks that can be performed by the controller 12 in step 64 of FIG. 2. In step 80, the controller determines if the ink tank 30a being replaced (referred to as the old ink tank) is a recognized ink tank that has not bee n previously emptied and refilled. By recognized it is meant that the ink tank 30a is an ink tank from a known manufacturer and/or contains a known ink, i.e., has not been refilled. This was determined when the ink tank 30a was placed into the system by the controller 12 obtaining information stored in the NVM 34 of ink tank 30a. Thus, for example, by reading one or more of the name of the manufacturer, a serial or identification number, or any other information that can be used to suitably and reliably identify the ink tank 30a, the controller 12 can determine if the ink tank 30a is a recognized ink supply. Controller 12 can, for example, compare the information read from the NVM 34 to information such as manufacturer names, ink tank serial numbers or identification numbers, etc. that has been previously stored, for example, in memory device 13, to determine if the ink tank 30a is a recognized ink tank. Such information can be included in the memory 13 when the mailing system 10 is manufactured to include those inks that have been tested and approved for use in the mailing system 10, and can be updated when the mailing system 10 is in the field to include additional inks that have been tested and deemed to be compatible with the approved inks. Thus, if an unknown ink tank is placed into the system 10, the controller 12 will not recognize the ink tank. In addition, if the ink tank 30a does not have an NVM 34, then the ink tank 30a is also deemed to be an unrecognized ink tank, as the controller 12 will not have any information to determine if the ink tank 30a is recognized or not.

If it is determined in step 80 that the old ink tank is not a recognized ink tank or if it is a recognized ink tank that has been refilled with an unknown ink, then in step 82 the inks from the old ink tank 30a and the new ink tank 30b will be deemed not compatible, since there is no information available to determine the composition and properties of the ink in the old ink tank. Thus, mixing of the old ink with the new ink may negative consequences with respect to the operation of the print head 16 and thus the overall performance of the system 10. Thus, regardless of the status of the new ink tank that is being placed into the system, if the old ink tank that is being replaced is not a recognized ink tank or has been refilled with an unknown ink, the inks will be deemed not compatible in step 64 of FIG. 2 and the maintenance operation as described in step 68 of FIG. 2 will occur.

If in step 80 it is determined that the old ink tank is a recognized ink tank that has not been refilled, then in step 84 it is determined if the new ink tank 30b is a recognized ink tank. This determination can be made by the controller 12 in a similar manner as described above with respect to step 80. If it is determined in step 84 that the new ink tank is not a recognized ink tank, then in step 82 the inks from the old ink tank 30a and the new ink tank 30b will be deemed not compatible, since there is no information available to determine the composition and properties of the ink in the new ink tank. Thus, mixing of the old ink with the new ink may have negative consequences with respect to the operation of the print head 16 and thus the overall performance of the system 10. Thus, if the new ink tank is not a recognized ink tank, the inks will be deemed not compatible in step 64 of FIG. 2 and the maintenance operation as described in step 68 of FIG. 2 will occur. If in step 84 the controller 12 determines that the ink tank 30b is a recognized ink tank, then in step 86 the controller 12 preferably determines if the ink tank 30b may have been refilled with an unknown ink supply. This can be performed, for example, based on the status of a flag included in the NVM 34. When an ink tank reaches the end of its ink supply, the controller 12 will cause a flag to be set in the NVM 34 that indicates that the tank has been emptied. If the ink tank is refilled and this flag is not reset to its original value, the status of the flag will indicate that the tank has been refilled with ink. It should be noted that step 86 is an optional step, which can be performed to determine if recognized ink tanks may have been refilled with ink whose properties are unknown and may cause problems when mixed with ink currently in the system 10 as described above.

Determination by the controller 12 that the ink tank 30b has already been emptied and refilled in step 86 (Yes answer) provides an indication that the ink contained within the ink tank may not be a known ink, and therefore the properties of the ink are also unknown. In such a case, it is not possible to determine the result of mixing the unknown ink from the ink tank 30b with the ink from the ink tank 30a that is being replaced that remains in the supply path 32 and/or print head 16. Processing will then go to step 82, where the inks from the old ink tank 30a and the new ink tank 30b will be deemed not compatible, since there is no information available to determine the composition and properties of the ink in the new ink tank 30b. Thus, if the new ink tank is recognized but has been refilled without resetting the memory flag, the inks will be deemed not compatible in step 64 of FIG. 2 and the maintenance operation as described in step 68 of FIG. 2 will occur.

If in step 86 it is determined that the ink tank 30b has not been previously emptied and refilled, then in step 88 the inks are deemed to be compatible, step 64 of FIG. 2 will result in a yes answer, the maintenance operation of step 68 will not be performed, and the system 10 will continue with normal operation in step 66 of FIG. 2.

Thus, mail processing system 10 according to the present invention includes several advantageous features with respect to printing operations and the supply of ink. The mail processing system 10 will ensure that the mixing of ink from a new ink tank that is inserted into the mail processing system 10 to replace a depleted old ink tank will be minimized, thereby significantly reducing or completely eliminating any negative consequences with respect to the operation of the print head 16 and thus the overall performance of the system 10 that such mixing may have. While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method for a mail processing system to operate, the mail processing system including a controller, a printing device for printing images, and a holding device to hold a replaceable ink tank that supplies ink to the printing device via a supply path, the method comprising:
receiving in the holding device a new ink tank to replace an old ink tank;
determining, by the controller, that ink from the new ink tank is deemed to be not compatible with ink from the old ink tank; and
the controller causing the printing device to perform a maintenance operation to remove ink remaining from the old ink tank in the supply path and printing device.

2. The method of claim 1, wherein determining that the ink from the new ink tank is deemed to be not compatible with ink from the old ink tank further comprises:
determining by the controller that the old ink tank is not a recognized ink tank.

3. The method of claim 2, wherein determining by the controller that the old ink tank is not a recognized ink tank further comprises:
obtaining information from a memory device attached to the old ink tank; and
comparing the obtained information to previously stored information to determine that the old ink tank is not a recognized ink tank.

4. The method of claim 3, wherein the previously stored information includes at least one of a manufacturer name, serial number, or identification number.

5. The method of claim 1, wherein determining that the ink from the new ink tank is deemed to be not compatible with ink from the old ink tank further comprises:
determining that at least one of the old ink tank or new ink tank has been refilled.

6. The method of claim 1, wherein determining that the ink from the new ink tank is deemed to be not compatible with ink from the old ink tank further comprises:
determining by the controller that the new ink tank is not a recognized ink tank.

7. The method of claim 6, wherein determining by the controller that the new ink tank is not a recognized ink tank further comprises:
obtaining information from a memory device attached to the new ink tank; and
comparing the obtained information to previously stored information to determine that the new ink tank is not a recognized ink tank.

8. The method of claim 7, wherein the previously stored information includes at least one of a manufacturer name, serial number, or identification number.

9. A mail processing system comprising:
a printing device for printing images;
a holding device to hold a replaceable ink tank;
a supply path coupling the replaceable ink tank in the holding device to the printing device to allow ink to flow from the ink tank to the printing device; and
a controller adapted to determine that ink from a new ink tank that is replacing an old ink tank in the holding device is deemed to be not compatible with ink from the old ink tank and to cause the printing device to perform a maintenance operation to remove ink remaining from the old ink tank in the supply path and printing device.

10. The system of claim 9, wherein the controller determines that the ink from the new ink tank is deemed to be not compatible with ink from the old ink tank by determining that the old ink tank is not a recognized ink tank.

11. The system of claim 10, wherein the holding device further comprises:
a connector to mate with a memory device provided on an ink tank inserted in the holding device,
wherein the controller obtains information from the memory device attached to the old ink tank and compares the obtained information to previously stored information to determine that the old ink tank is not a recognized ink tank.

12. The system of claim 11, wherein the previously stored information includes at least one of a manufacturer name, serial number, or identification number.

13. The system of claim 9, wherein the controller is adapted to determine that the ink from the new ink tank is deemed to be not compatible with ink from the old ink tank if at least one of the old ink tank or new ink tank has been refilled.

14. The system of claim 9, wherein the controller determines that the ink from the new ink tank is deemed to be not compatible with ink from the old ink tank by determining that the new ink tank is not a recognized ink tank.

15. The system of claim 9, wherein the holding device further comprises:
a connector to mate with a memory device provided on an ink tank inserted in the holding device,
wherein the controller obtains information from the memory device attached to the new ink tank and compares the obtained information to previously stored information to determine that the new ink tank is not a recognized ink tank.

16. The system of claim 15, wherein the previously stored information includes at least one of a manufacturer name, serial number, or identification number.
